(19) United States
(12) Patent Application Publication
(10) Pub. No.: US 2014/0252293 A1
(43) Pub. Date: Sep. 11, 2014

(54) GATE SYSTEM

(71) Applicant: Galen Miller, Topeka, IN (US)

(72) Inventor: Galen Miller, Topeka, IN (US)

(21) Appl. No.: 14/175,436

(22) Filed: Feb. 7, 2014

Related U.S. Application Data
(60) Provisional application No. 61/774,032, filed on Mar. 7, 2013.

(51) Int. Cl. E06B 11/02

(52) U.S. Cl. CPC E06B 11/02
USPC 256/73; 29/428; 29/525.01

(57) ABSTRACT

A gate system including at least one post extending from a ground surface and a gate assembly extending from the post. The gate assembly includes at least one gatepost coupled to the post, at least one rail and at least one gate block. The gate block is inserted into the gatepost, and the rail is inserted into the gatepost and the gate block.

### CROSS REFERENCE TO RELATED APPLICATIONS

This is a non-provisional application based upon U.S. provisional patent application serial no. 61/774,032, entitled “GATE SYSTEM”, filed Mar. 7, 2013, which is incorporated herein by reference.

### BACKGROUND OF THE INVENTION

1. Field of the Invention

The present invention relates to a gate associated with fencing, and, more particularly, to a gate with hollow gateposts.

2. Description of the Related Art

A gateway is a point of entry to a space enclosed by walls, or a fence. A gate may be used to prevent or control the entry or exit of individuals, livestock and/or traffic through the gateway. A gate may be fully functional or merely decorative. A gate often has hinges, which allow it to swing and a latch to keep it from swinging and a lock for security.

Fences are formed from a large variety of materials, including stone, wood, metal and plastic. Often fences will have posts that are placed in the ground and there are rails, fencing, wire or in general some material extending between the posts to provide a barrier. At gateways a gate can be provided that may be made of a material similar to the fence or may be made of a contrasting material. A gate generally needs to be light enough to be moved when it is desired to be opened or closed and the gate needs to have adequate strength to act as a barrier when closed.

Vinyl fences provide good looking, low maintenance, borders to property and allow for the ease of construction. However, in some applications metal inserts are used to strengthen portions of the fence or porch railings. Vinyl gates are available and they are generally either a substantially solid panel or have some corner pieces that extend in both the horizontal and vertical direction. The reason for these approaches is to overcome a tendency of a gate to sag from the hinges unless adequate strength can be extended from the hinge side of the gate to the latch side of the gate. Bracing wires or angled structural members can be incorporated into the gate to provide the needed strength, but such additions can be unsightly or provide a pattern that departs from the pattern of the rest of the fence. Solid panels solve the sag problem by effectively providing the angled support which is inherent in the panel itself. The solution using the corner pieces requires the providing of specialized external parts that are incorporated only in a gate construct.

Rail fencing typically has two to four rails that extend between adjacent posts. Typically the gates depart from the pattern of the rail fence because the rail construct, without some accommodation, previously discussed, has an inherent tendency to sag.

What is needed in the art is an easy and inexpensive way to construct a rail gate mainly using the components used in the fencing that prevents sagging of the gate.

### SUMMARY OF THE INVENTION

The present invention provides a rigid rail gate for use within a gateway.

The invention in one form is directed to a gate system including at least one post extending from a ground surface and a gate assembly extending from the post. The gate assembly includes at least one gatepost coupled to the post, at least one rail and at least one gate block. The gate block is inserted into the gatepost, and the rail is inserted into the gatepost and the gate block.

The invention in another form is directed to a gate assembly including at least one gatepost, at least one rail and at least one gate block. The gate block is inserted into the gatepost, and the rail is inserted into the gatepost and the gate block.

The invention in yet another form is directed to a method of constructing a gate assembly including two inserting steps. The first inserting step includes inserting at least one gate block into a gatepost. The second inserting step includes inserting an end of a first rail into the gatepost and the gate block.

An advantage of the present invention is that a sturdy gate with all of the fasteners needed to construct the gate being hidden.

Another advantage of the present invention is that the gate blocks provide the installer a secure area to install the hinge and latching devices when the gate is hung.

Yet another advantage of the present invention is that the combination of the gate blocks, the rails and the screws provide a robust resilient assembly that can be easily assembled and disassembled.

Yet another advantage of the present invention is that it allows the use of fencing members (shortened posts and rails) to construct a gate, with the addition of the gate blocks and internal fasteners.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates an embodiment of a gate of the present invention;

FIG. 2 illustrates the parts of the gate of FIG. 1 prior to assembly;

FIG. 3 illustrates the insertion of a gate block and a rail of FIG. 2 into a gatepost and how the rail is secured thereto; and

FIG. 4 shows the gate of FIG. 1 used as part of a fence system.

Corresponding reference characters indicate corresponding parts throughout the several views. The exemplification set out herein illustrates an embodiment of the invention and such exemplification is not to be construed as limiting the scope of the invention in any manner.

### DETAILED DESCRIPTION OF THE INVENTION

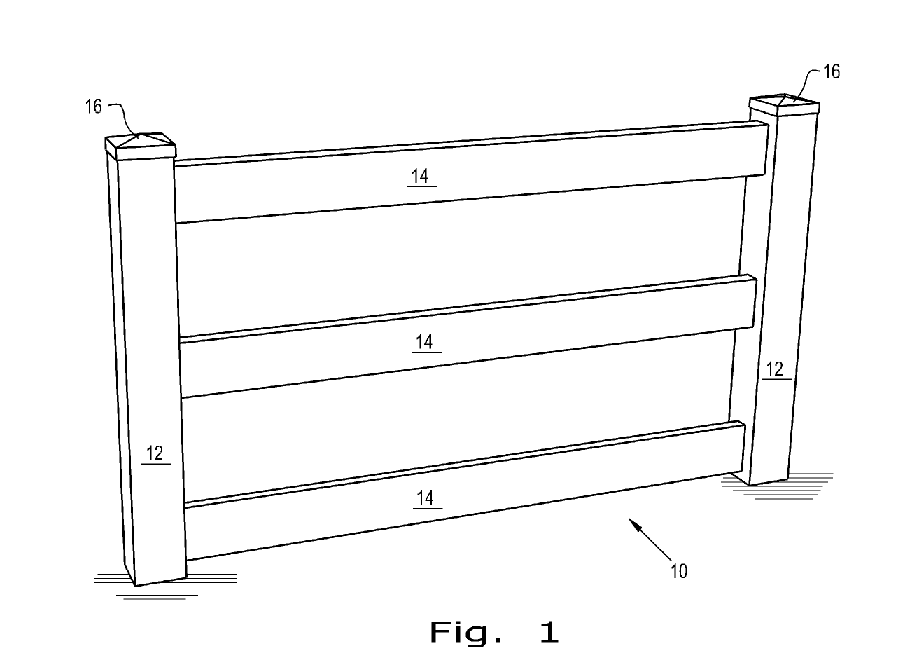

Referring now to the drawings, and more particularly to FIG. 1, there is shown a gate 10 including gateposts 12, rails 14 and caps 16. For purposes of this application the word “gatepost” is meant to convey the meaning of the vertically extending portion of the gate and not the meaning of a post installed into the ground.

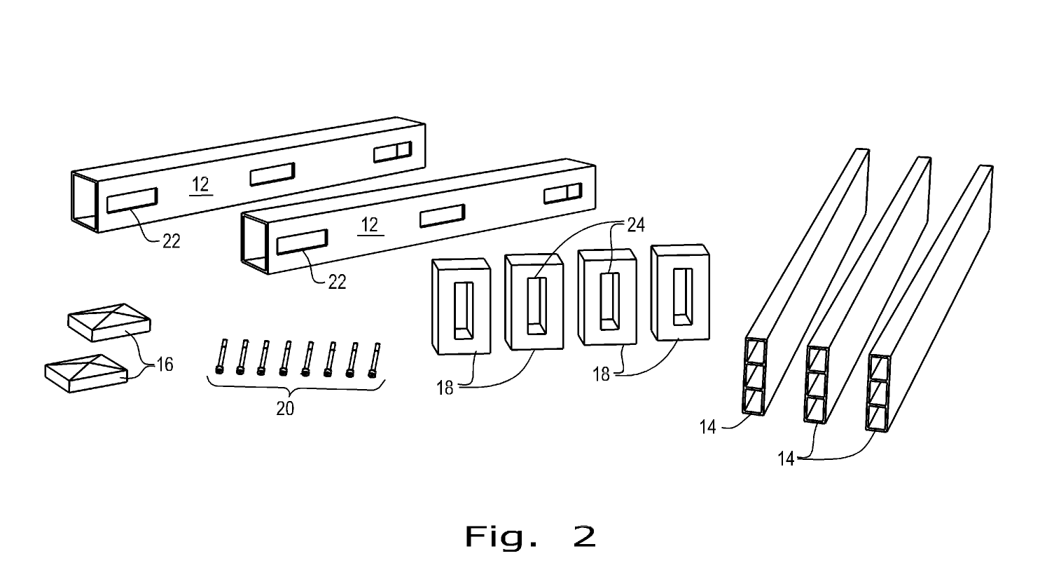

Now, additionally referring to FIG. 2, gateposts 12, rails 14 and caps 16 are shown in an unassembled state. Additionally shown are concealed gate blocks 18 and fasteners 20, which may be in the form of timber screws 20. Gateposts 12 have openings 22 into which rails 14 are inserted during the assembly process. Gate blocks 18 are inserted into each end of gatepost 12 to align openings 24 of gate blocks 18 with openings 22 (only the two openings 22 at the ends of gateposts 12). It is also contemplated that an extended gate block could be used to provide the rigidity provided by gate blocks 18, with the extended gate block extending to both ends of gatepost 12. However, for ease of explanation of the present invention, and for ease of use in the construction process, and the ability to use the present invention regardless of the number of rails, or the rail spacing, two gate blocks 18 will be used in each gatepost 12, one for the top rail and one for the bottom rail.

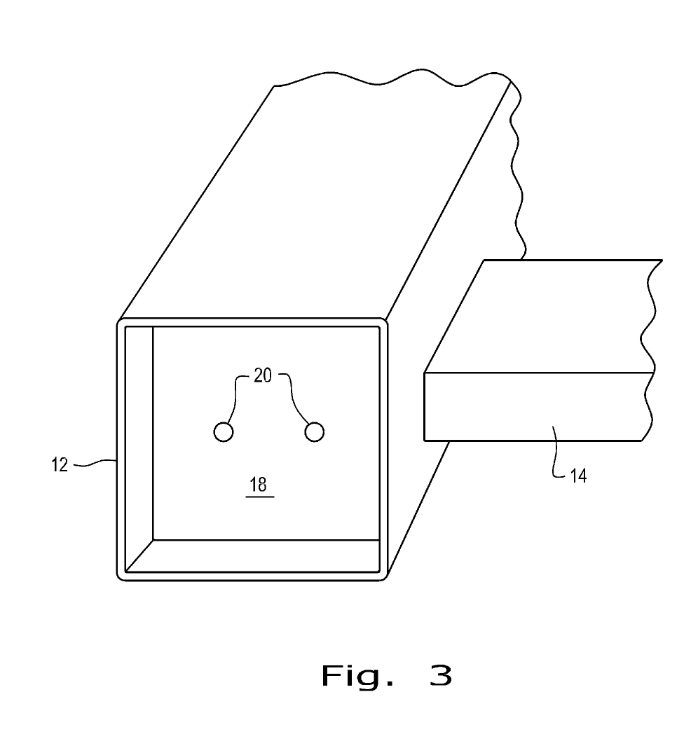

Now, additionally referring to FIG. 3 there is shown a partial section of an end of a gatepost 12 having a rail 14 inserted through openings 22 and 24. Rail 14 extends completely (or at least substantially) through gate block 18 and may abut an interior wall of gatepost 12. At least one screw 20 is screwed perpendicularly through the face of gate block 18. Screws 20 may be long enough to extend completely through rail 14 and into the opposite portion of gate block 18.

In the assembly process the four gate blocks 18 are slid into position in gateposts 12 aligning openings 22 and 24. Gate blocks 18 may be sized to exhibit a slight interference fit so that they fit snugly within gateposts 12. Gate blocks 18 may be made of polyurethane, or any other suitable material. Rails 14 are then inserted into appropriate openings 22 and gate 10 is checked for squareness and adjusted as needed. Once any needed adjustments are made, then screws 20 are inserted in each of the ends of gateposts 12 and are driven through gate blocks 18 and rails 14. Caps 16 are installed on the top ends of gateposts 12 and gate 10 is ready for installation. Screws 20 are directed in a direction that is substantially parallel with the longitudinal axes of gateposts 12 and substantially perpendicular to the longitudinal axes of rails 14. Typically two screws 20 will be used to secure the rails extending into each gate block 18. The combination of screws 20 and gate blocks 20 secure rails 14 to gateposts 12 to establish a rigid gate 10.

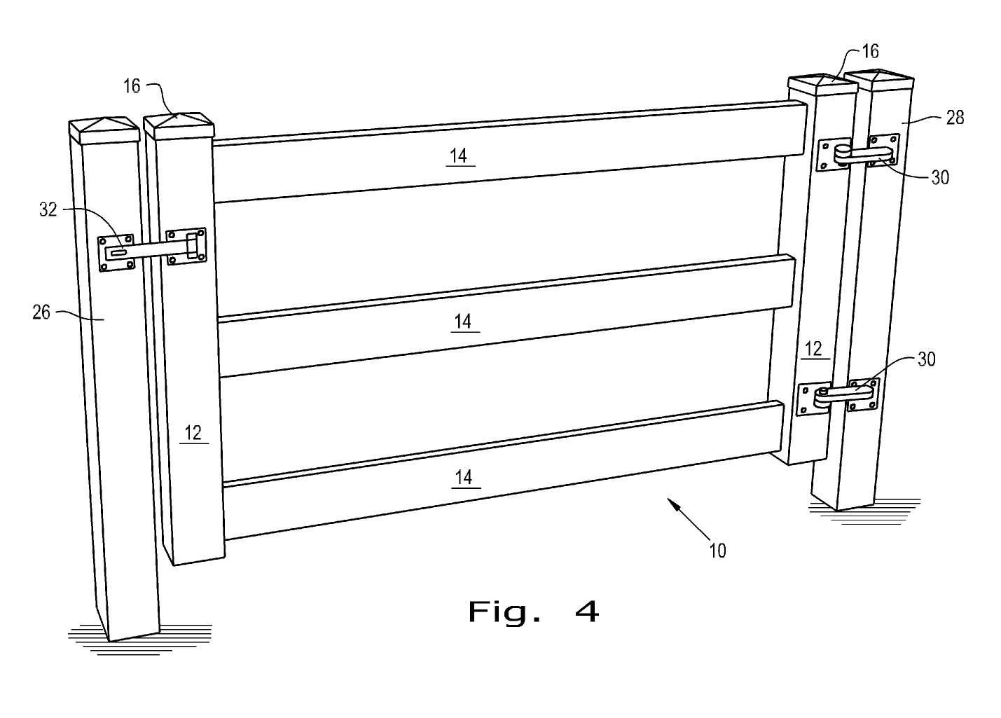

Now, additionally referring to FIG. 4, there is illustrated a gate system with gate 10 positioned between fence posts 26 and 28. Gate 10 is suspended on the right side by two hinges 30 and is held in a closed position by latch system 32. The attachment fasteners of hinges 30 may be positioned to at least partially engage gate blocks 18 and rails 14.

It is also contemplated that gate blocks 18 could be used in at least the first span of fence that would extend from fence posts 26 and 28. This will enhance the strength of the fence and particularly help keep fence posts 26 and 28 in proper position relative to gate 10. Although substantially square posts and rectangular rails have been illustrated, it is also contemplated that other shapes, with likewise modified changes to gate blocks 18 can be used to construct gate 10.

Advantageously the present invention provides a sturdy gate with all of the fasteners hidden. Further, gate blocks 18 provide the installer a secure area to install the hinge and latching devices when gate 10 is hung. Yet further, the combination of gate blocks 18, rails 14 and screws 20 provide a robust resilient assembly that can be easily assembled and disassembled. Still further, the present invention allow the use of the rail fencing members to be used to construct a gate, with the addition of gate blocks 18 and fasteners 20.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A gate system, comprising:
at least one post extending from a ground surface; and
a gate assembly extending from said at least one post, said gate assembly including:
at least one gatepost coupled to said post;
at least one rail; and
at least one gate block inserted into said at least one gatepost, said at least one rail being inserted into said gatepost and said gate block.

2. The gate system of claim 1, wherein said gate assembly further includes at least one fastener, said fastener coupling said at least one rail to said at least one gate block.

3. The gate system of claim 2, wherein said at least one gatepost is a plurality of gateposts including a first gatepost and a second gatepost, said at least one gate block being a plurality of gate blocks including a first gate block and a second gate block, said first gate block being inserted into said first gatepost, said second gate block being inserted into said second gatepost, said rail having a first end inserted into said first gatepost and into said first gate block, said rail having a second end inserted into said second gatepost and into said second gate block.

4. The gate system of claim 3, wherein said plurality of gate blocks additionally include a third gate block and a fourth gate block, said at least one rail is a plurality of rails including a first rail and a second rail, said first rail being installed as previously described, said third gate block being inserted into said first gatepost, said fourth gate block being inserted into said second gatepost, said second rail being inserted into said first gatepost and said third gate block, said second rail also being inserted into said second gatepost and said fourth gate block.

5. The gate system of claim 4, wherein said at least one fastener is a plurality of fasteners, with at least one fastener being used to couple each said gate block to a corresponding portion of a corresponding one of said rails.

6. The gate system of claim 5, wherein said plurality of rails include a third rail a portion of which is inserted into said first gatepost and an other portion of said third rail being inserted into said second gatepost.

7. The gate system of claim 6, wherein said third rail is not inserted into a gate block.

8. A gate assembly, comprising:
at least one gatepost;
at least one rail; and
at least one gate block inserted into said at least one gatepost, said at least one rail being inserted into said gatepost and said gate block.

9. The gate assembly of claim 8, further comprising at least one fastener, said fastener coupling said at least one rail to said at least one gate block.

10. The gate assembly of claim 9, wherein said at least one gatepost is a plurality of gateposts including a first gatepost and a second gatepost, said at least one gate block being a plurality of gate blocks including a first gate block and a second gate block, said first gate block being inserted into said first gatepost, said second gate block being inserted into said second gatepost, said rail having a first end inserted into said first gatepost and into said first gate block, said rail having a second end inserted into said second gatepost and into said second gate block.

11. The gate assembly of claim 10, wherein said plurality of gate blocks additionally include a third gate block and a fourth gate block, said at least one rail is a plurality of rails including a first rail and a second rail, said first rail being installed as previously described, said third gate block being inserted into said first gatepost, said fourth gate block being inserted into said second gatepost, said second rail being inserted into said first gatepost and said third gate block, said second rail also being inserted into said second gatepost and said fourth gate block.

12. The gate assembly of claim 11, wherein said at least one fastener is a plurality of fasteners, with at least one fastener being used to couple each said gate block to a corresponding portion of a corresponding one of said rails.

13. The gate assembly of claim 12, wherein said plurality of rails include a third rail a portion of which is inserted into said first gatepost and an other portion of said third rail being inserted into said second gatepost.

14. The gate assembly of claim 6, wherein said third rail is not inserted into a gate block.

15. A method of constructing a gate assembly, comprising the steps of:
inserting at least one gate block into a gatepost; and
inserting an end of a first rail into said gatepost and said gate block.

16. The method of claim 15, further comprising the step of coupling said first rail to said at least one gate block using at least one fastener.

17. The method of claim 16, further comprising the steps of:
inserting two gate blocks into an other gatepost; and
inserting an other end of said first rail into said second gatepost and one of said two gate blocks.

18. The method of claim 17, further comprising the step of inserting a second rail into said gatepost and into said other gatepost.

19. The method of claim 18, wherein said at least one fastener is a plurality of fasteners, with at least one fastener being used to couple each said gate block to a corresponding portion of a corresponding one of said rails.

20. The method of claim 19, further comprising the step of inserting portions of a third rail into said gatepost and into said other gatepost, said third rail not being inserted into a gate block.
